(19) United States
(12) Patent Application Publication
(10) Pub. No.: US 2018/0197142 A1
(43) Pub. Date: Jul. 12, 2018

(54) TRAILER TRACKING SYSTEM USING MOBILE DEVICE

(71) Applicant: Hyundai Translead, San Diego, CA (US)

(72) Inventor: Won Hee PARK, San Diego, CA (US)

(21) Appl. No.: 15/456,281

(22) Filed: Mar. 10, 2017

Related U.S. Application Data
(60) Provisional application No. 62/443,436, filed on Jan. 6, 2017.

(51) Int. Cl. G06Q 10/08; G08G 1/00; G06K 19/06; G06F 17/30; H04W 4/04

(52) U.S. Cl. CPC G06Q 10/0838; G08G 1/205; G06F 17/30867; G06F 17/30312; H04W 4/046; G06K 19/06037

(57) ABSTRACT

Providing fleet management of a plurality of trailers owned by a company using mobile devices, including: providing an identifier code on each of the plurality of trailers to identify each trailer; enabling a driver of each trailer to scan and upload the identifier code along with a location information of each trailer using a fleet management application installed on a mobile device of the driver; receiving the identifier code and the location information from each trailer of the plurality of trailers; aggregating the received information from the plurality of trailers owned by the company; and presenting the aggregated information on a fleet management website to a manager of the company.

### CROSS-REFERENCE TO RELATED APPLICATIONS

This application claims the benefit of priority under 35 U.S.C. § 119(e) of co-pending U.S. Provisional Patent Application No. 62/443,436, filed Jan. 6, 2017, entitled “Trailer Tracking System using Mobile Device.” The disclosure of the above-referenced application is incorporated herein by reference.

### BACKGROUND

### Field of the Invention

The present disclosure relates generally to managing and tracking a fleet of trailers, and more specifically, managing and tracking a fleet of trailers using mobile devices.

### Background

Operators of fleet vehicle businesses need to know where each vehicle in the fleet is located and what it is doing in order to make decisions on how to use the vehicles most efficiently. Recently, vehicle location systems have been developed using Global Positioning System (GPS) receivers. These systems are highly accurate where line of sight (LOS) conditions exist. However, the cost of buying and deploying the GPS receivers on the fleet of vehicles can be very expensive for small operations. Further, the cost of maintaining the receivers and managing the status of vehicles using the GPS receivers further adds to the cost. Managing the fleet may also incur the cost for contracts with service providers.

### SUMMARY

The present disclosure describes managing and tracking a fleet of trailers using mobile devices.

In one embodiment, a method to provide fleet management of a plurality of trailers owned by a company using mobile devices is disclosed. The method includes: providing an identifier code on each of the plurality of trailers to identify each trailer; enabling a driver of each trailer to scan and upload the identifier code along with a location information of each trailer using a fleet management application installed on a mobile device of the driver; receiving the identifier code and the location information from each trailer of the plurality of trailers; aggregating the received information from the plurality of trailers owned by the company; and presenting the aggregated information on a fleet management website to a manager of the company.

In another embodiment, a system for managing a plurality of trailers owned by a company using mobile devices is disclosed. The system includes: a mobile device owned by a driver of each trailer of the plurality of trailers, the mobile device installed with a fleet management application to scan and upload an identifier code of each trailer and a location information of each trailer; and a fleet management database configured to receive and store the identifier code and the location information from each trailer, the fleet management database also configured to aggregate the received information from the plurality of trailers owned by the company.

Other features and advantages of the present disclosure should be apparent from the present description which illustrates, by way of example, aspects of the present disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1A is a flow diagram for providing fleet management of a fleet of trailers in accordance with one embodiment of the present disclosure;

FIG. 1B is a block diagram showing the units providing fleet management of a fleet of trailers in accordance with one embodiment of the present disclosure;

FIG. 2A is a flowchart for providing information needed for fleet management from the driver side in accordance with one embodiment of the present disclosure;

FIG. 2B shows one example screen of the application which allows the driver to sign in and identify himself or herself;

FIG. 2C shows one example screen of the application which allows the driver to track and trace the delivery status on the screen;

FIG. 2D shows one example screen of the application which allows the driver to obtain the proof of delivery upon arriving at the destination;

FIG. 3A is a flowchart for receiving and presenting information needed for fleet management viewed from the company side (by a manager) in accordance with one embodiment of the present disclosure;

FIG. 3B shows one example log-in screen of the fleet management website which allows the manager to sign in and review the overall delivery status of the trailers for the company;

FIG. 3C show one example of the dashboard screen showing the overall delivery status of the trailers for the company;

FIG. 3D show one example of the track and trace screen showing the list of trailers in transit;

FIG. 3E shows one example of the tracking log screen;

FIG. 3F shows one example of the delivery history screen with key word search tools; and

FIG. 3G shows one example of the proof of delivery screen showing the signed work order.

### DETAILED DESCRIPTION

As stated above, the current configuration of managing a fleet of vehicles may use a system of GPS receivers. However, the cost of buying, deploying, maintaining, and managing the GPS receivers on the fleet of vehicles can be expensive.

Several embodiments of a fleet management system are proposed herein to provide fleet management of trailers using fleet management applications installed on mobile devices. After reading this description it will become apparent how to implement the present disclosure in various embodiments and applications. However, although various embodiments of the present disclosure will be described herein, it is understood that these embodiments are presented by way of example only, and not limitation. As such, this detailed description of various embodiments should not be construed to limit the scope or breadth of the present disclosure.

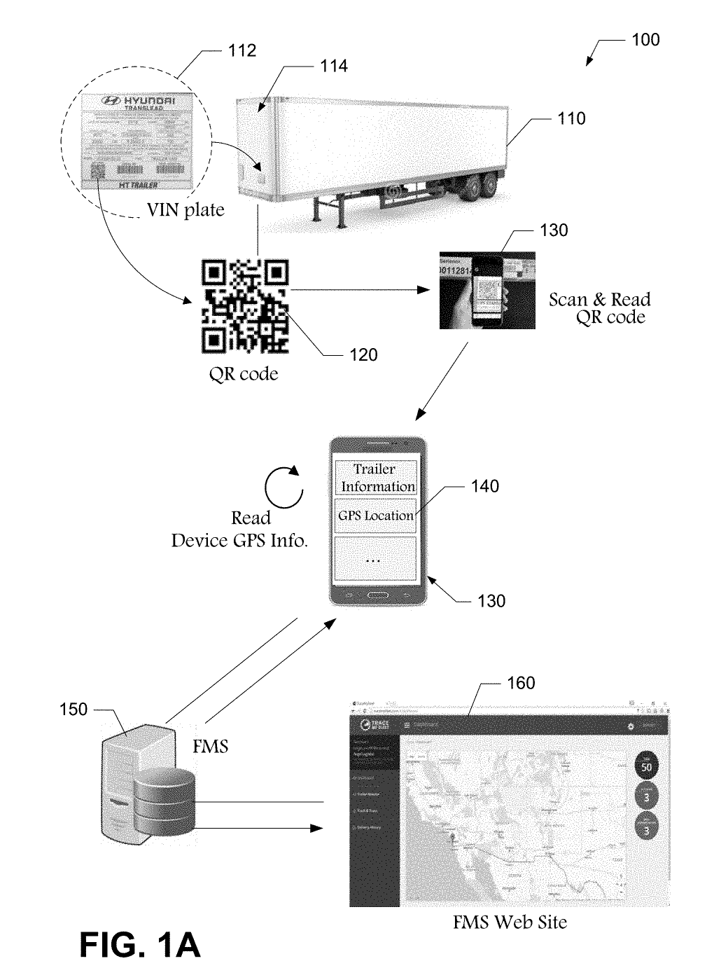

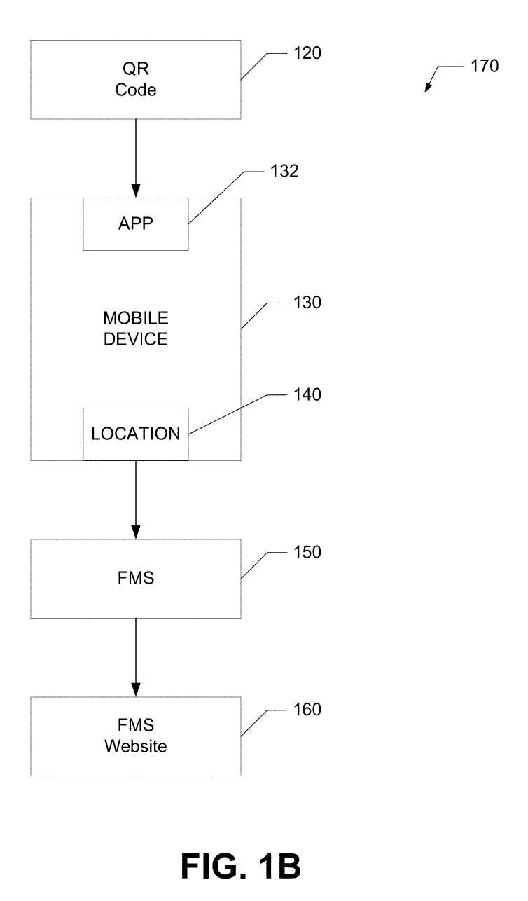

FIG. 1A is a flow diagram 100 for providing fleet management of a fleet of trailers for a company in accordance with one embodiment of the present disclosure. In one embodiment, the trailers are truck trailers. In the illustrated embodiment of FIG. 1A, each trailer 110 of a fleet of trailers has an identifier code, such as a quick response (QR) code 120, attached to a vehicle identification number (VIN) plate 112, which is usually placed on the front surface 114 of the trailer. This identifier code identifies the trailer and the website to which the trailer status is uploaded. In other embodiments, other identifying marks (other than the QR code) that can be read and recognized by the mobile device 130 may be used. In one embodiment, the mobile device 130 is a smartphone. In another embodiment, the mobile device 130 is a laptop or tablet computer which includes a location fix capability and an image capturing capabilities.

In one embodiment, when an authorized driver comes to pick up the trailer 110, the driver already has the fleet management application installed on the mobile device 130. The driver uses the application of the mobile device 130 to scan and read the QR code 120, which logs the trailer-driver pair information into the fleet management system 150. The application also reads and uploads the GPS location information obtained from the mobile device 130 to the fleet management system 150. Other information such as trailer information may also be uploaded to the fleet management system 150. Once the information from the mobile device 130 is uploaded to the fleet management system 150, the system 150 enters/stores the information into a management database. The fleet management system 150 also updates the fleet management website 160 using the management database.

In one embodiment, the fleet management system 150 receives information from trailers belonging to many different companies. Thus, the fleet management system 150 classifies the trailer information into companies and allows the manager of a particular company to view the trailer information of his/her own company only on the website. In another embodiment, the manager who represents more than one company may view and manage trailer information of several different companies.

FIG. 1B is a block diagram 170 showing the units providing fleet management of a fleet of trailers in accordance with one embodiment of the present disclosure. In the illustrated embodiment of FIG. 1B, the application 132 installed on the mobile device 130 is used to scan the QR code 120 on the VIN plate of the trailers. This action registers the trailer-driver pair information and uploads the location information of the trailer to the fleet management system 150, which updates the fleet management website 160.

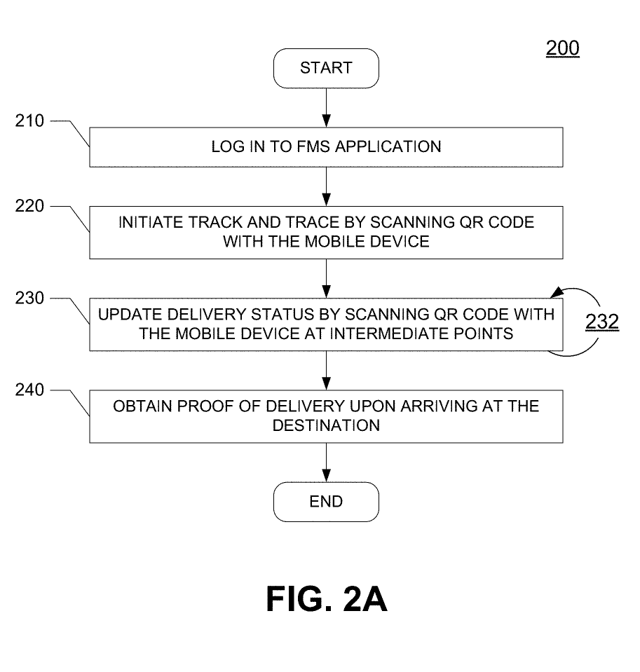

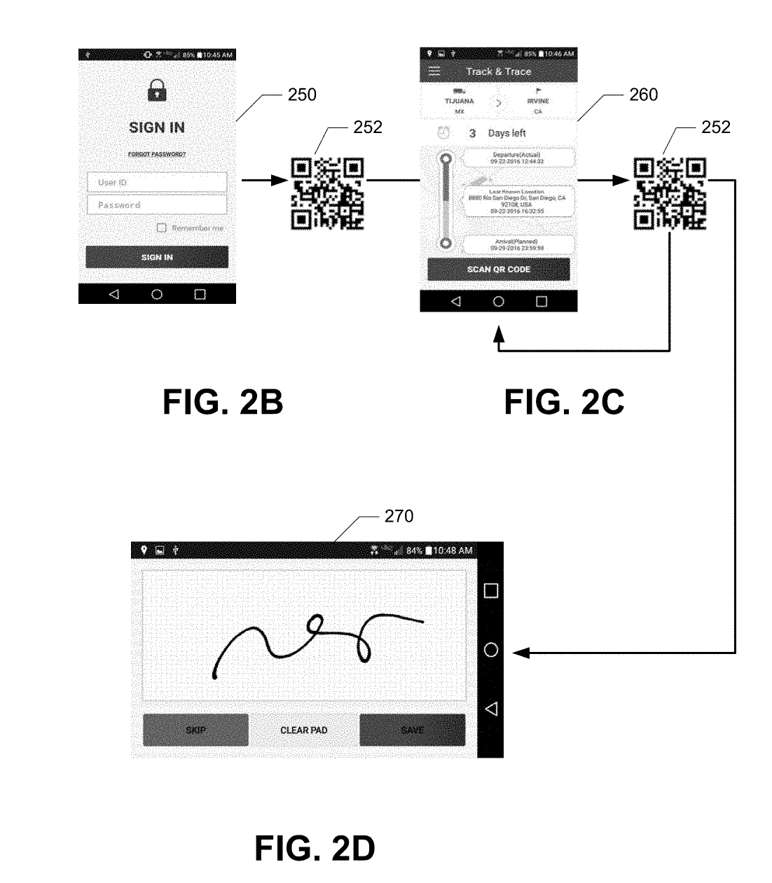

FIG. 2A is a flowchart 200 for providing information needed for fleet management from the driver side in accordance with one embodiment of the present disclosure. In the illustrated embodiment of FIG. 2A, the driver logs into the fleet management application installed on the mobile device, at block 210, and initiates track and trace of the trailer by scanning the QR code on the VIN plate of the trailer with the mobile device, at block 220. Once the driver installs the fleet management application on his or her mobile device, logs into the application, and registers, the driver becomes an authorized driver. Thus, the authorized driver can use the application to scan and read the QR code 120 and pick up the trailer.

At intermediate points between the pickup spot and the destination, the delivery status can be updated, at block 230, by scanning the QR code again and uploading the location information (and other information, if desired) to the fleet management system. This process maybe repeated, as shown with arrow 232, as many times as necessary. In some embodiments, the driver can enable the application to constantly update the delivery status by allowing the mobile device to upload the location information periodically. In other embodiment, the application prompts the driver to enter audio status of the delivery by orally entering the status into the mobile device. The fleet management system receives the audio status, performs speech recognition, and uploads the transformed status note to the fleet management website. Finally, at block 240, the proof of delivery is obtained by the driver on the application upon arriving at the destination. In one embodiment, the proof is automatically uploaded by the application to the fleet management system.

FIG. 2B shows one example screen 250 of the application which allows the driver to sign in and identify himself or herself. Once signed in, the driver scans the QR code 252.

FIG. 2C shows one example screen 260 of the application which allows the driver to track and trace the delivery status on the screen. The delivery status can be updated by scanning the QR code 252 again and uploading the location information to the fleet management system.

FIG. 2D shows one example screen 270 of the application which allows the driver to obtain the proof of delivery upon arriving at the destination. Again, the proof of delivery can be uploaded to the fleet management system by the application.

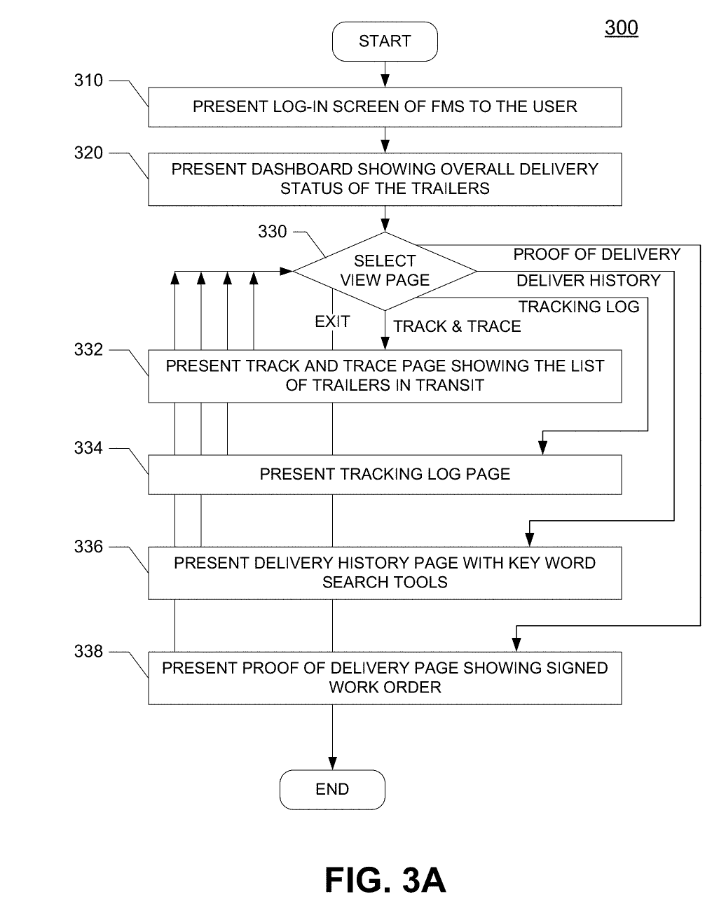

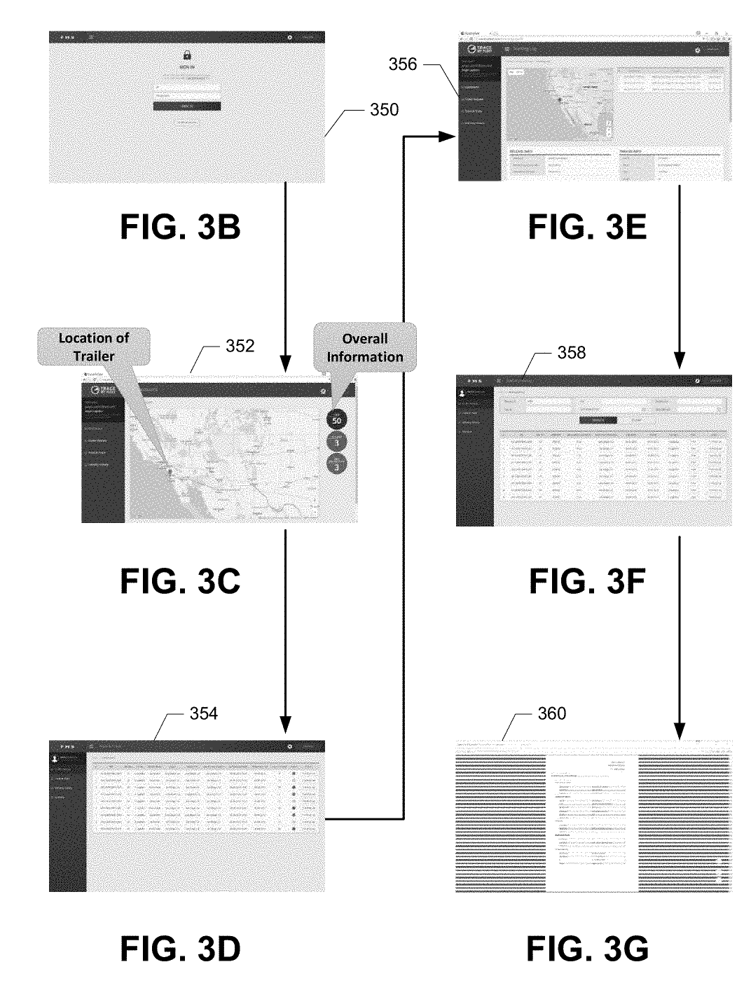

FIG. 3A is a flowchart 300 for receiving and presenting information needed for fleet management viewed from the company side (by a manager) in accordance with one embodiment of the present disclosure. In one embodiment, the company may own and manage a plurality of trailers, wherein each trailer is assigned to a driver who can update the delivery status with the application installed on the mobile device in accordance with the flowchart shown in FIG. 2A. The trailer(s) not assigned to any driver can be assigned to a lot where the trailer is parked and can be picked up.

In the illustrated embodiment of FIG. 3A, the company manager logs into the website of the fleet management system, at block 310, and reviews the dashboard showing the overall delivery status of the trailers for the company, at block 320. The manager then selects, at block 330, a desired view page. If the manager selects a track and trace page, the track and trace page showing the list of trailers in transit is presented to the manager, at block 332. If the manager selects a tracking log page, the tracking log page is presented to the manager, at block 334. If the manager selects a delivery history page, the delivery history page with key word search tools is presented to the manager, at block 336. If the manager selects a proof of delivery page, the proof of delivery page showing the signed work order is presented to the manager, at block 338. In other embodiment many different pages with desired information can be presented. For example, a page showing the performance of the driver can be presented based on the timing and/or speed information uploaded by the application.

FIG. 3B shows one example log-in screen 350 of the fleet management website which allows the manager to sign in and review the overall delivery status of the trailers for the company.

FIG. 3C show one example of the dashboard screen 352 showing the overall delivery status of the trailers for the company. In one embodiment show in FIG. 3C, the dashboard screen 352 shows the map of the locations of the trailers and the overall information summary including the total number of trailers, the number of trailers in transit, the number of trailers that missed the planned arrival, etc.

FIG. 3D show one example of the track and trace screen 354 showing the list of trailers in transit.

FIG. 3E shows one example of the tracking log screen 356. In one embodiment show in FIG. 3E, the tracking log screen 356 shows the timestamp, the location, the name of the driver, the planned departure date, the planned arrival date, and the trailer information including the VIN, the type of trailer, and the length.

FIG. 3F shows one example of the delivery history screen 358 with key word search tools.

FIG. 3G shows one example of the proof of delivery screen 360 showing the signed work order.

One embodiment includes one or more programmable processors and corresponding computer system components which store and execute computer instructions, such as to provide fleet management of a fleet of trailers.

The above description of the disclosed embodiments is provided to enable any person skilled in the art to make or use the invention as described in the specification presented above. Various modifications to these embodiments will be readily apparent to those skilled in the art, and the generic principles described herein can be applied to other embodiments without departing from the spirit or scope of the disclosure. Accordingly, the techniques are not limited to the specific examples described above. Thus, it is to be understood that the description and drawings presented herein represent a presently possible embodiment of the disclosure and are therefore representative of the subject matter that is broadly contemplated by the present disclosure. It is further understood that the scope of the present disclosure fully encompasses other embodiments that may become obvious to those skilled in the art and that the scope of the present disclosure is accordingly limited by nothing other than the appended claims.

1. A method to provide fleet management of a plurality of trailers owned by a company using mobile devices, the method comprising:
providing an identifier code on each of the plurality of trailers to identify each trailer;
enabling a driver of each trailer to scan and upload the identifier code along with a location information of each trailer using a fleet management application installed on a mobile device of the driver;
receiving the identifier code and the location information from each trailer of the plurality of trailers;
aggregating the received information from the plurality of trailers owned by the company; and
presenting the aggregated information on a fleet management website to a manager of the company.

2. The method of claim 1, wherein the identifier code is a QR code.

3. The method of claim 1, wherein the mobile device is a smartphone.

4. The method of claim 1, further comprising
requesting the driver to install the fleet management application on the mobile device of the driver.

5. The method of claim 1, further comprising
periodically updating the location information of each trailer from the mobile device of the driver.

6. The method of claim 1, further comprising:
storing the received information into a management database; and
updating the fleet management website using the stored information.

7. The method of claim 1, wherein the aggregated information on the fleet management website includes an overall delivery status of the plurality of trailers owned by the company.

8. The method of claim 7, wherein the overall delivery status includes
a map of locations of the plurality of trailers, a total number of trailers, a number of trailers in transit, and a number of trailers that missed the planned arrival.

9. The method of claim 1, wherein the fleet management website further includes
a track and trace page showing a list of trailers in transit.

10. The method of claim 1, wherein the fleet management website further includes
a tracking log page showing a timestamp, a location, a number of the driver, a planned departure date, a planned arrival date, and trailer information.

11. The method of claim 10, wherein the trailer information includes
a vehicle identification number, a type of each trailer, and a length of each trailer.

12. The method of claim 1, wherein the fleet management website further includes
a delivery history page having search tools.

13. The method of claim 1, wherein the fleet management website further includes
a proof of delivery page showing a signed work order.

14. A system for managing a plurality of trailers owned by a company using mobile devices, the system comprising:
a mobile device owned by a driver of each trailer of the plurality of trailers, the mobile device installed with a fleet management application to scan and upload an identifier code of each trailer and a location information of each trailer; and
a fleet management database configured to receive and store the identifier code and the location information from each trailer, the fleet management database also configured to aggregate the received information from the plurality of trailers owned by the company.

15. The system of claim 14, further comprising
a fleet management website configured to present the aggregated information.
